(19) United States
(12) Patent Application Publication
(10) Pub. No.: US 2013/0254056 A1
(43) Pub. Date: Sep. 26, 2013

(54) HYBRID PURCHASE METHOD FOR PRINTED AND ELECTRONIC DISTRIBUTION OF COMPILATION OF WORKS

(71) Applicants: Toshiro FUJIMORI, Laguna Beach, CA (US); Taisuke AKAHORI, Tokyo (JP); David ASAO, Irvine, CA (US); Philip WU, Seal Beach, CA (US); Daniel BARBER, Tustin, CA (US)

(72) Inventors: Toshiro FUJIMORI, Laguna Beach, CA (US); Taisuke AKAHORI, Tokyo (JP); David ASAO, Irvine, CA (US); Philip WU, Seal Beach, CA (US); Daniel BARBER, Tustin, CA (US)

(73) Assignee: KONICA MINOLTA LABORATORY U.S.A., INC., San Mateo, CA (US)

(21) Appl. No.: 13/427,601

(22) Filed: Mar. 22, 2012

(51) Int. Cl. G06Q 30/06

(52) U.S. Cl. 705/26.1

(57) ABSTRACT

A method for controlling rights for purchasing and using a compilation of works, including the steps of compiling the compilation of works, obtaining rights to use the compilation of works in different formats, setting different options for a user to purchase the rights to use the compilation of works in different formats, and allowing a user to purchase the rights to use the compilation of works with different options such that they may be exercised based on the user's needs.

### BACKGROUND OF THE INVENTION

1. Field of the Invention

This invention generally relates to a method for distributing compilation of works, and in particular, it relates to a hybrid purchasing model for printed and electronic distribution of compilation of works.

2. Description of Related Art

Traditionally, books, publications, compilation of works as course booklets used in educational institutions and training manuals used in organizations are traditionally distributed in print forms where the readers would purchase and receive hard copies of the printed work. In recent years, with the rapid development and wide adoption of a variety of electronic devices such as laptop computers, tablet computers, smart phones, e-book readers, etc., many of such printed work are now increasingly available in electronic forms and can be delivered electronically such that they can be viewed on an electronic device.

However, generally speaking, the purchase and delivery schemes currently available still basically treat the purchasing printed copies and the electronic copies of the same work as two separate transactions. For example, a user or customer may buy a printed copy of a work for a price, and buy an electronic copy of the same work for another price. While the price for the electronic copy may be less than the price for the printed copy because the electronic copy can be delivered electronically without the costs associated with the labor and materials of the printing process, the user or customer may nonetheless still be paying twice for the costs associated with copyright license or permission fees. In addition, the currently available dual-track delivery schemes of printed and electronic forms of the same work do not provide adequate flexibility and versatility to the customer, for example, who may need only a portion of the work in one form at a time. Moreover, the currently available delivery schemes of printed and electronic forms of the same work generally do not fully utilize the customized printing options made available by the adoption of advanced print-on-demand (POD) technologies. For example, advanced POD printing processes now make it possible to print hard copy of a booklet on an individually tailored level, such that a customer may specify the contents of the booklet to be printed, and the number of copies to be printed.

Therefore there is a need to provide a new purchasing model for printed and electronic distribution of works that takes advantage of the advanced POD technologies and is more flexible and adoptive to individual users' needs of different contents in different forms at different time and locations.

### SUMMARY

The present invention is directed to a new hybrid purchasing method for printed and electronic distribution of compilation of works that provide more flexibility and customization to individual users' needs of different contents in different forms at different time and locations, while taking full advantage of the advanced POD technologies in distributing contents of a work or compilation of works in printed and electronic forms.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for controlling rights for purchasing and using a compilation of works, including the steps of compiling the compilation of works, obtaining rights to use the compilation of works in different formats, setting different options for a user to purchase the rights to use the compilation of works in different formats, and allowing a user to purchase the rights to use the compilation of works with different options such that they may be exercised based on the user's needs.

In another aspect, one exemplary embodiment of the present invention further provides a computer program product that causes a data processing apparatus to perform the above methods. The computer program product includes a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates an exemplary environment in which embodiments of the present invention may be implemented.

FIG. 2 schematically illustrates an exemplary process in accordance with an embodiment of the present invention.

FIGS. 3-12 illustrate screen shots from executing various steps of the exemplary process as shown in FIG. 2.

### DETAILED DESCRIPTION OF PREFERRED EMBODIMENTS

Embodiments of the present invention provide a new purchasing model for printed and electronic distribution of works that takes advantage of the advanced POD technologies and is more flexible and adoptive to individual users' needs of different contents in different forms at different locations and different times.

As an example of practical scenarios of the need for providing a hybrid purchase model for printed and electronic distribution of works, a teacher or professor in an educational institution may assemble educational materials as a course booklet for the students to purchase and read. As another example of practical scenarios of such need, an instructor or trainer of a business entity or organization may assemble training materials as an instruction manual for the members to purchase and use.

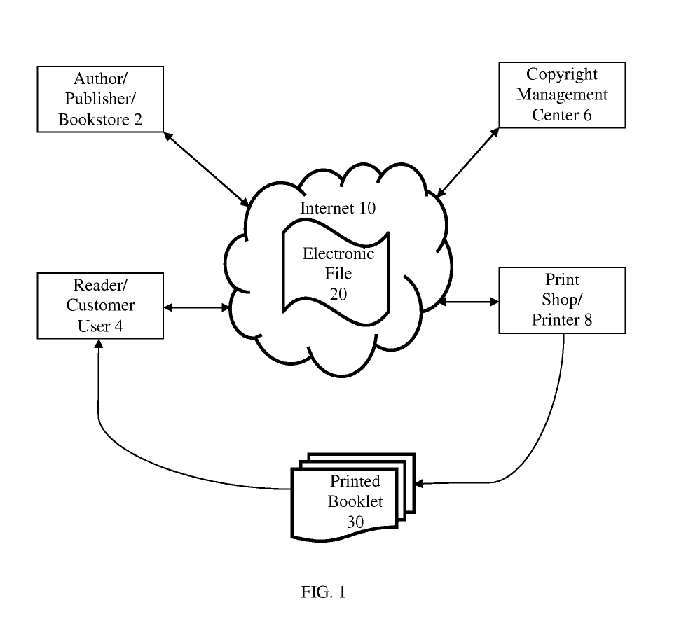

Referring to FIG. 1, there is schematically illustrated an exemplary online and offline environment in which embodiments of the present invention may be implemented. The exemplary online and offline environment includes an author, publisher or bookstore 2, a reader, customer or user 4, one or more copyright management centers 6, and a print shop or printer 8, connected via one or more computer network 10 such as the Internet or other communication links. The author (such as a teacher or a trainer) or publisher or bookstore 2 may have, operate or use a server to access the network 10 and interact with the reader or customer or user 4, the copyright management center 6 and the printer or print shop 8. The reader (such as a student or a member of an organization) or customer or user 4 may have, operate or use a device such as a laptop computer, a desk-top computer, a tablet computer, an e-reader, or a smart phone, etc., to access the computer network 10 and interact with the author or publisher or bookstore 2, and the printer or print shop 8. The printer or print shop 8 may have, operate or use a server to access the network 10 and interact with the author or publisher or bookstore 2, and the reader or customer or user 4. The server, computers or other electronic devices each may execute a computer program stored in a memory to perform processes according to the embodiments of the present invention. The copyright management centers 6 maintains digital contents and associated copyright data or license information that may be obtained for use by the authors and readers. The print shop 8 may be a professional print shop equipped with printers and various other image reproduction machines for producing printed products such as books, booklets, etc. The print shop server also manages the print jobs submitted to the print shop by the author or reader.

The server of the publisher or bookstore 2 generally provides an integrated service that allows an author to search and acquire contents from content sources, to compile them into an electronic file and submit the compiled file to a print-on-demand (POD) service to produce a printed product, and to order and purchase the printed product of the compiled works. The reader 4 may access the server of the publisher or bookstore 2 from their own computers or electronic devices via the network 10 once they establish their user accounts on the server of the publisher or bookstore. The server of the publisher or bookstore 2 interacts with the server of the copyright management center 6 for searching and obtaining contents of the works to be compiled. The server of the publisher or bookstore 2 also interacts with the server of the print shop or printer 8 for printing and delivering the compiled works in hard copy or electronic forms.

In this application, the term “copyright management center” generally refers to a place or service that facilitates the management and distribution of copyrighted materials and the obtaining and transferring of payment to copyright holders. Typically, a copyright management center facilitates legitimate access to copyrighted content by providing a copyright registry, where users can locate copyright information about a work, by also providing a copyright marketplace exchange, where users can buy and sell copyrights, and by further providing a copyright clearance service that can connect with third party distribution platforms. Examples of such copyright management centers may include digital repository of published work maintained by some publishers or digital libraries maintained by various organizations. Another example of copyright management center is the Copyright Clearance Center.

Therefore, “copyright management center 6” of the environment shown in FIG. 1 may include any types of sources of digital contents and their copyright data and license information. More generally, “copyright management center 6” of the environment shown in FIG. 1 may also include any third party content sources such as databases or depositories where hard or electronic copies of articles, publications or other contents and works may be stored or otherwise kept.

The physical locations or the commercial relationship among the various components of the online environment shown in FIG. 1 are not important. For example, the server of the publisher or bookstore may be operated by the copyright management center, or the print shop, or a separate institution, organization or commercial establishment.

Also in this application the term “user” generally refers to an author, a reader, a customer or anyone who uses the method or related apparatus provided by the embodiments of the present invention. For example, it may refer to a teacher or student in an educational institute, or an instructor or a member in an organization. Specifically for the process described in this application, “author” or “booklet compiler” (or “compiler”) refers to anyone who manages the contents or articles, and generates compilation of works from the contents or articles, and “customer” or “booklet reader” (or “reader”) refers to anyone who orders the printing or delivery of the finished product of the compilation of works that have already been generated. For example, a compiler may be a teacher in an educational institute or an instructor of an organization, whereas a reader may be a student in the educational institute or a member of the organization who would like to have printed material or booklet for the study or use, while preferring the convenience of, e.g., a tablet computer, for reading the material in a mobile environment.

Both the compilers and the readers may have access accounts at the server of the publisher or bookstore 2 and share some common rights or features on the server, but some of their other rights may be different. For example, a compiler may have right to generate a booklet from compilation of works, whereas a reader may not have such right but may have right to order the booklet. These details will become more apparent and clear in the description below.

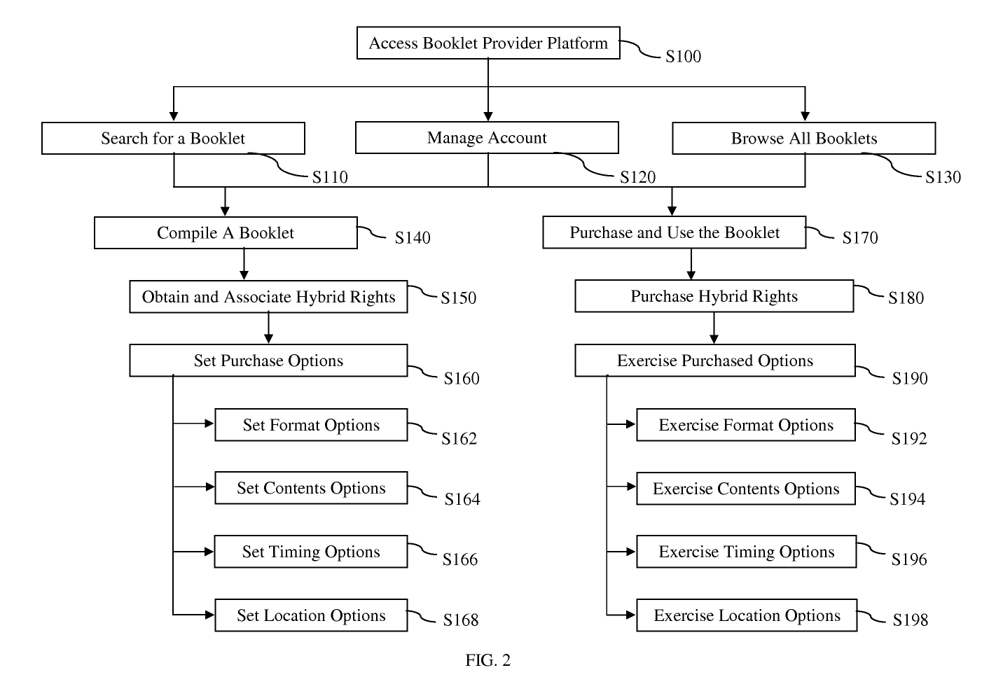

As mentioned earlier, in one aspect the present invention is embodied a computer program product that causes a data processing apparatus to perform the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the process of the present invention as shown in FIG. 2. A graphic user interface (GUI) is preferably provided to allow a user to interact with the program to perform various steps of the process.

Referring to FIG. 2, there is shown a schematic illustration of an exemplary process as parts of a computer-implemented method for a new purchasing model for printed and electronic distribution of works that takes advantage of the advanced POD technologies and is more flexible and adoptive to individual users' needs of different contents in different forms at different times and different locations.

As Step S100 shown in FIG. 2, a user accesses the booklet provider's platform, such as the server of a publisher or bookstore, by accessing, e.g., the web-site of the provider. The user typically needs to provide a valid username and a matching password to log in.

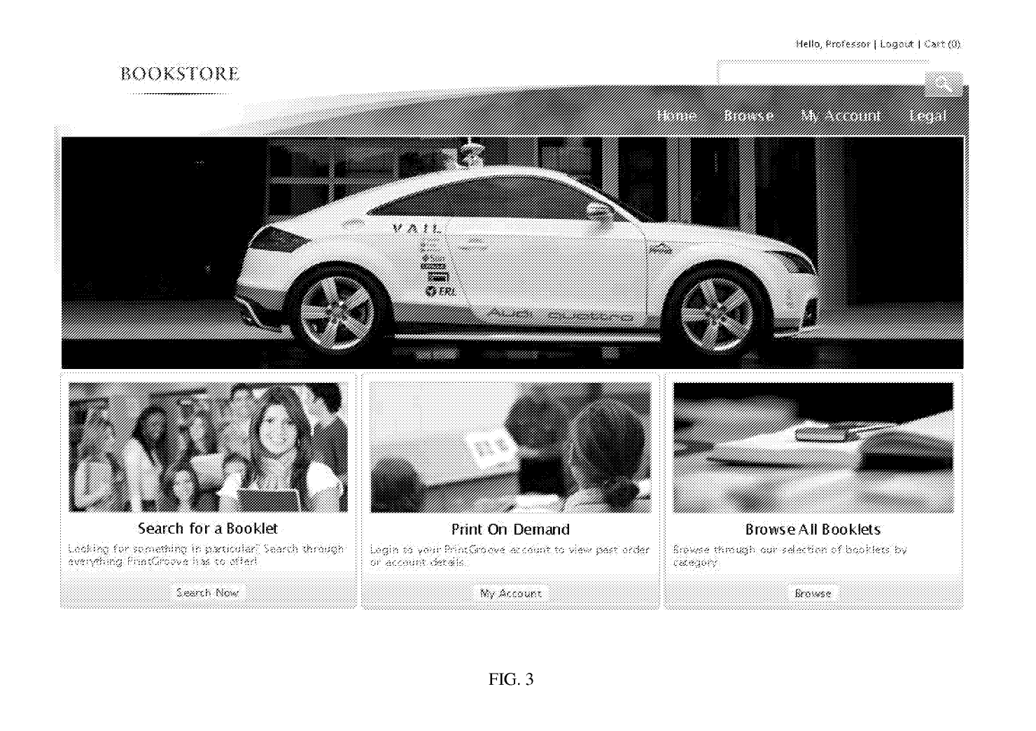

Referring to FIG. 3, there is shown a screen shot of an exemplary GUI display of the home page of the booklet provider's web-site, in this example an online bookstore, after the user logs into the web-site. From this home page the user may search for a booklet by click on “Search Now” at the lower left portion of the screen, as Step S110 (“Search for A Booklet”) shown in FIG. 2. The user may also access his or her account by clicking on, e.g., “My Account” at either the top menu bar or the lower middle portion of the screen, as Step S120 (“Manage Account”) shown in FIG. 2. The user may further browse all booklets by clicking on, e.g., “Browse” at either the top menu bar or the lower right portion of the screen, as Step 130 (“Browse All Booklets”) shown in FIG. 2.

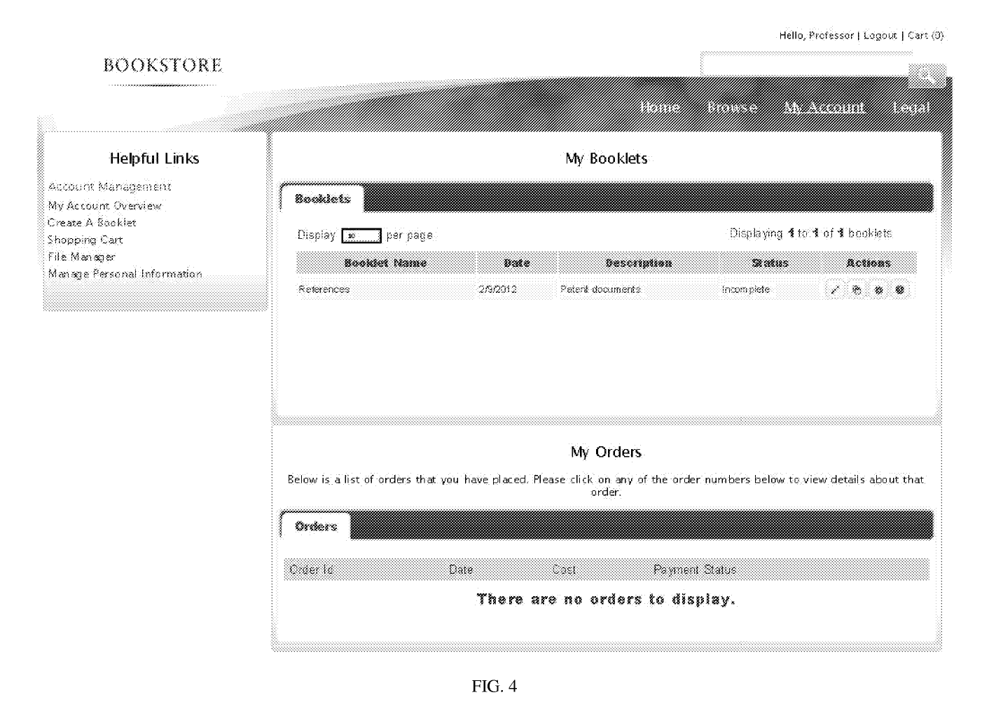

As mentioned above, at Step S120 shown in FIG. 2, the user can access his or her account by clicking on, e.g., “My Account” at either the top menu bar or the lower middle portion of the screen shown in FIG. 3. This takes the user to the “Account Overview” page as shown in FIG. 4.

Referring to FIG. 4, there is shown a screen shot of an exemplary GUI display of the “Account Overview” page of the online platform web-site. On this page the user may see a list of the booklets that have been generated or is in progress, and also the status of all orders placed by the user. On the booklet list, each booklet is listed with its name, date of creation, its brief description, and its status. For example, a booklet in progress may be listed as “incomplete” (in progress), “ready” (generated but not activated for ordering), or “active” (activated for ordering). Under the “actions” menu heading at the end of the book list, there are icons for actions that may be taken on each of the booklet. For example, the action icons may include an icon for editing the booklet information, an icon for editing the booklet files, an icon for editing print options, and an icon for activating/deactivating the booklet.

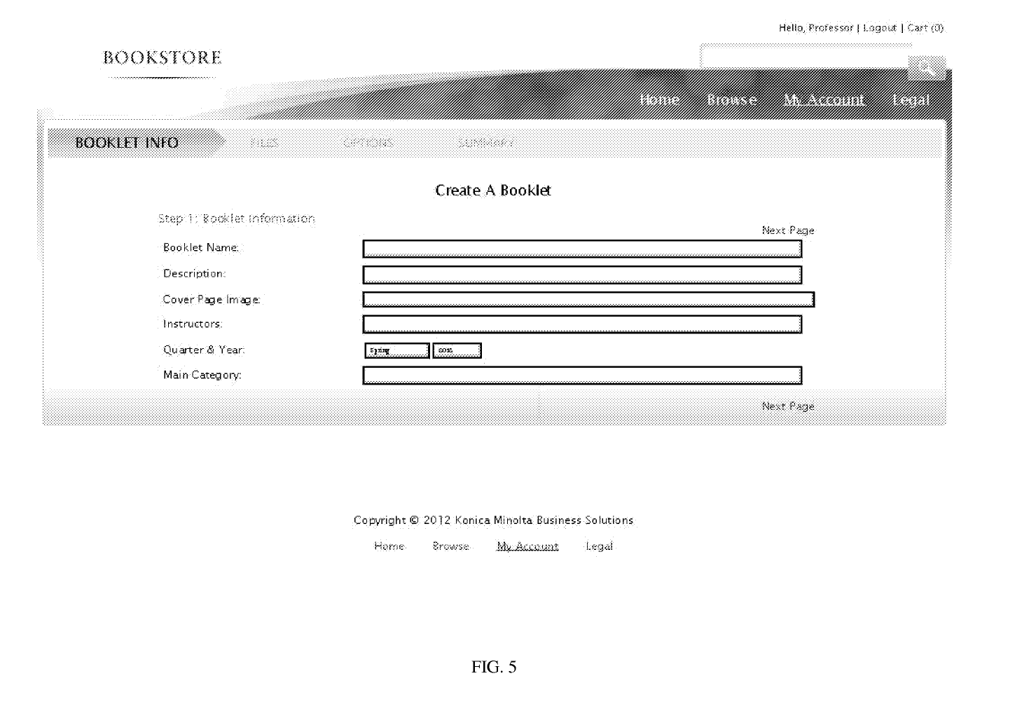

Alternatively as mentioned earlier, at Step 140 shown in FIG. 2 the user may create a new booklet by clicking on the “Create A Booklet” link at the left portion of the page shown in FIG. 4 or any other page where such a link is provided, which will link to the “Create A Booklet” page as shown in FIG. 5.

Referring to FIG. 5, there is shown a screen shot of an exemplary GUI display of the “Create A Booklet” page of the online platform web-site. The user enters booklet information. The UI shown in FIG. 5 provides text boxes for the compiler to input the name and description of the booklet. An image may also be uploaded from the user's local computer, e.g., the customer computer 4 shown in FIG. 1, to the server of the online platform provider shown in FIG. 1. In this example the booklet is created for an educational institution, so the compiler may also enter the course instructor's name, the quarter and school year during which the booklet will be used, and the main category of the booklet.

A booklet may include multiple articles with metadata that may be used to retrieve correct intellectual property (IP) rights such as copyrights. Some of the articles in the booklet may already have associate IP rights, e.g., the articles retrieved from a database of the copyright management center 6 shown in FIG. 1. Some of the articles in the booklet may not have IP right yet, e.g., the articles uploaded by the user. However, all necessary IP rights will be obtained by the online platform before the booklet is released, e.g., ready for purchase by readers. The IP rights of the booklet may be paid for later when the booklet is purchased.

Some of the articles in the booklet may have pricing information as well. The price of an article may be based on a number of factors, e.g. the number of pages, membership or affiliation of the author and/or the readers, etc. The metadata and other information of the articles may be sent to the copyright management center 6 shown in FIG. 1 for calculating the price of the articles included in the booklet.

It is noted that as part of the booklet creation process, after a booklet compilation is done, the online platform server may access the copyright management center databases to retrieve IP and price information of the articles used in the booklet to calculate pricing for the readers. The online platform program module will make sure that all articles have appropriate permissions such as the print permission.

At Step 150 shown in FIG. 2 the necessary rights for printing the booklet or delivering it in electronic form are obtained and associated with the booklet and preferably with each individual one of the all articles and other contents in the booklet, such as multimedia contents. The rights associated to the booklet and its contents are “hybrid” in the sense that such rights will grant permissions for using the booklet and its contents in either or both printed or electronic forms. It may result in a saving to the readers because this hybrid right model will purchase or obtain IP rights such as copyrights for both the electronic format and the print format, thereby making rights for both formats available without the readers paying double price. For example, if the price for obtaining copyright of an article is C, then since delivering the article in electronic format does not incur any printing costs P, the price for the article delivered in electronic format will just be C. If the booklet is to be delivered in print format, then the price for the hard copy will be C+P. Traditionally if a reader is purchasing a hard copy for a price of C+P, and also purchasing an electronic copy for price of C, then the reader's total price for purchasing both the hard copy and the electronic copy of the booklet is C+P+C=2C+P. Under the hybrid purchased model according to an embodiment of the present invention, the reader's price for purchasing an electronic copy of the booklet will be C and if the reader later decides to get print copy as well, the additional price that the reader needs to pay only at the time of printing is C. So the reader's total price for the hybrid purchase is only C+P, not 2C+P.

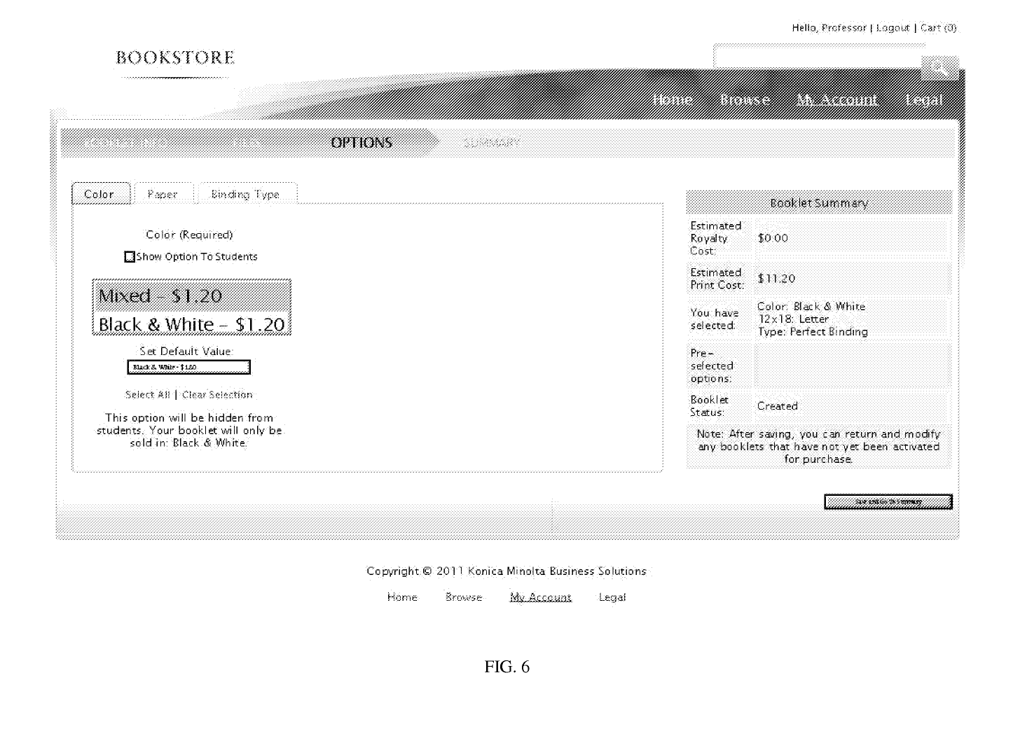

At Step S160 shown in FIG. 2 the author or compiler of the booklet may set the hybrid purchase options for the booklet. The GUI provided to the author or compiler at the online platform web-site is designed to make this a smooth process, e.g., as seen in FIG. 6 which shows a screen shot of an exemplary GUI display of the “Options” page of the online platform web-site. From this page the compiler may set various options for purchasing the booklet. Pricing information for the different options may be displayed.

Referring to FIG. 2, an author or compiler of the booklet may set various hybrid purchase options to a booklet, including, e.g., format options, contents options, timing options, location options, etc. At Step 162 the author or compiler may set the format options, which will allow the readers to purchase the booklet in either the electronic or print form or both. At Step 164 the author or compiler may set the contents options, which will allow the readers to selectively use certain contents in one form but other contents in another form. At Step 166 the author or compiler may set the timing options, which will allow the readers to exercise their rights at different time periods. At Step 168 the author or compiler may set the location options, which will allow the readers to exercise their rights at different locations.

The hybrid purchase model of the exemplary embodiments of the present invention provides great flexibility and customization to a reader or customer needs. As seen in FIG. 2, at Step S170 a reader or user may purchase and use a booklet. Generally the steps shown in FIG. 2 reflect the steps that a reader or customer will take to purchase a booklet on the server that provides the online platform 2, or at the customer's device 4, as shown in FIG. 1. Of course anyone who has the access to the server and the authority to search for and purchase activated booklets on the server can take these steps to search and purchase booklets on the server, not necessarily a reader. For example a compiler will essentially go through the same process to order and purchase a print copy of a booklet and the GUI pages for the compiler are basically the same as the ones that will be described below.

At Step S170 shown in FIG. 2, a reader can begin the step of purchasing a booklet by accessing the online platform by, e.g., access the web-site of the online platform. The reader also needs to provide a valid username and a matching password to log in. Once logged in, the reader will see the same home page as shown in FIG. 3, from which the reader may search for a booklet by clicking on “Search Now” button at the lower left portion of the screen, or browse all available booklets by clicking on the “Browse” button at either the top menu bar or the lower right portion of the screen, or access his or her account by clicking on, e.g., “My Account” button at either the top menu bar or the lower middle portion of the screen.

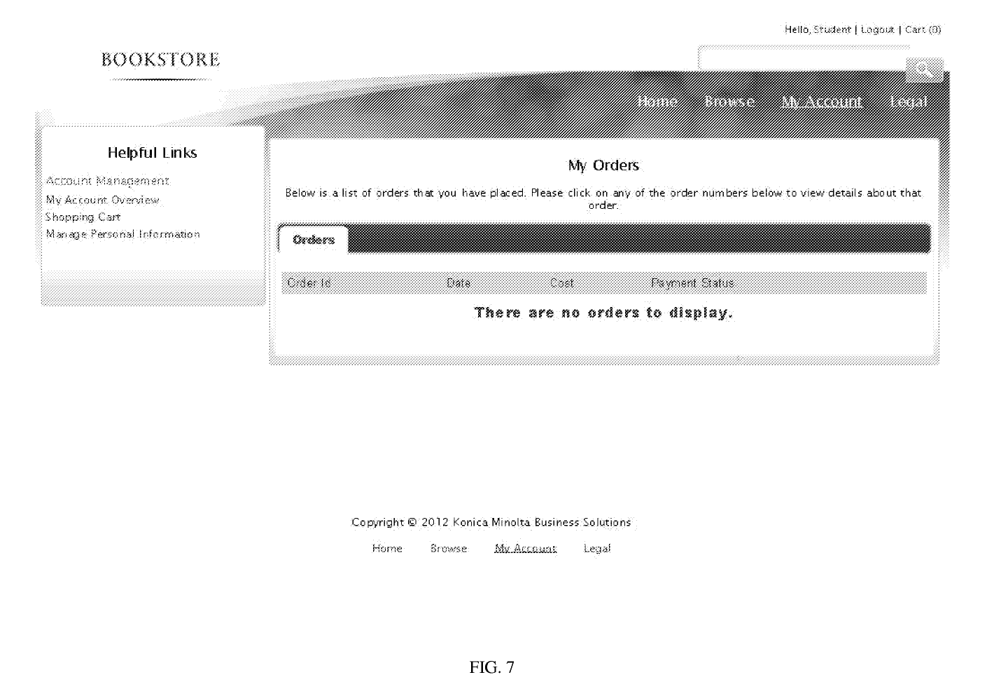

When the reader proceeds to access his or her account by clicking on, e.g., “My Account” button at either the top menu bar or the lower middle portion of the screen, the account overview page will be displayed as shown in FIG. 7.

Referring to FIG. 7, there is shown a screen shot of an exemplary UI display of a reader's “Account Overview” page of the online platform web-site. On this page the reader may see a list of the booklets that have been ordered by the reader and the status of all orders placed by the compiler. From this page the reader may click on the “Browse” button to browse all activated booklets that are available for purchase, which has the same effect as clicking on the “Browse All Booklets” button at the lower right portion of the screen shown in FIG. 3.

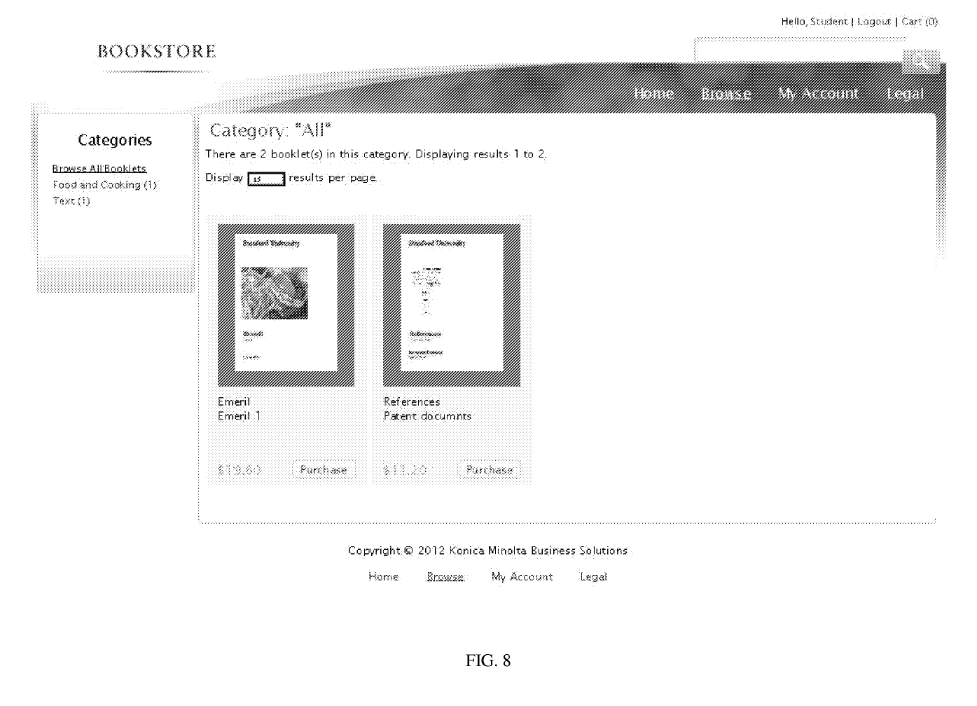

When the reader browses all booklets either by clicking on the “Browse” button at the top menu bar or the “Browse All Booklets” button at the lower right portion of the page shown in FIG. 3, or by clicking on the “Browse” button at the top menu bar from the “Account Overview” page shown in FIG. 7, all booklets that are available for purchase are searched for and displayed in a page as shown in FIG. 8.

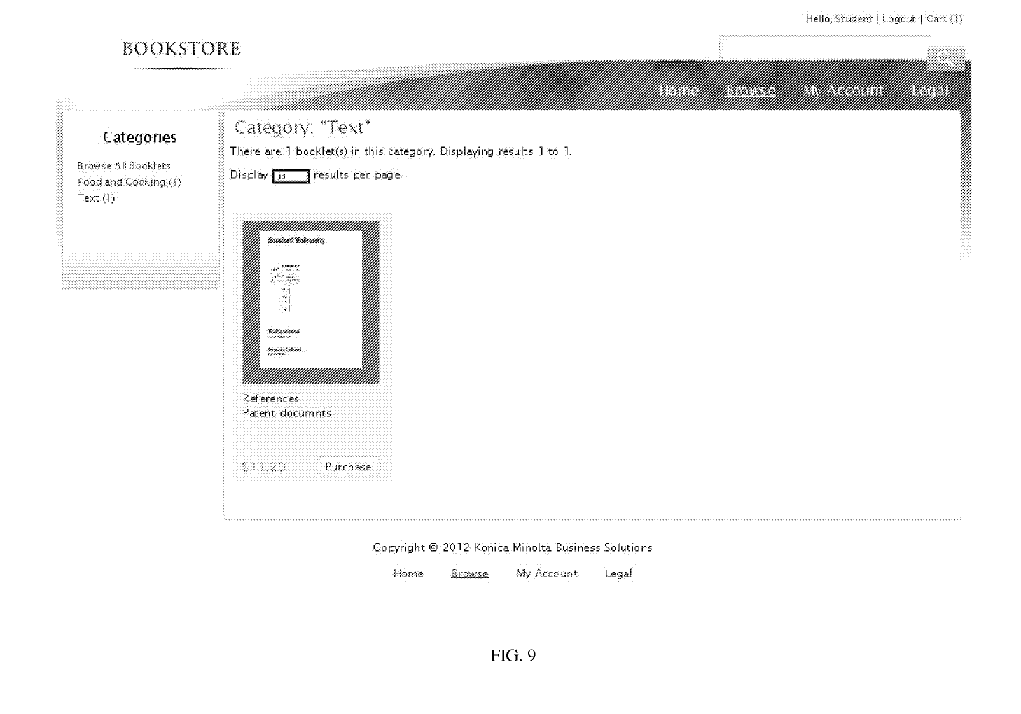

Referring to FIG. 8, all search results for available booklets of all categories are displayed. Again, booklets may be displayed according to their categories. The reader may search booklets of a particular category by clicking on the link of the category at the left portion of the page shown in FIG. 8, so that only the booklets of the selected category will be searched for and displayed. For example by clicking on the “Text” category link at the left portion of the page, only the booklet(s) belong to the “Text” category will be displayed, as shown in FIG. 9.

Referring to FIG. 9, there is shown the browse result for the selected category, e.g. “Text”. In the example shown in FIG. 9, the booklet “Reference—Patent Documents” is in this category and therefore displayed.

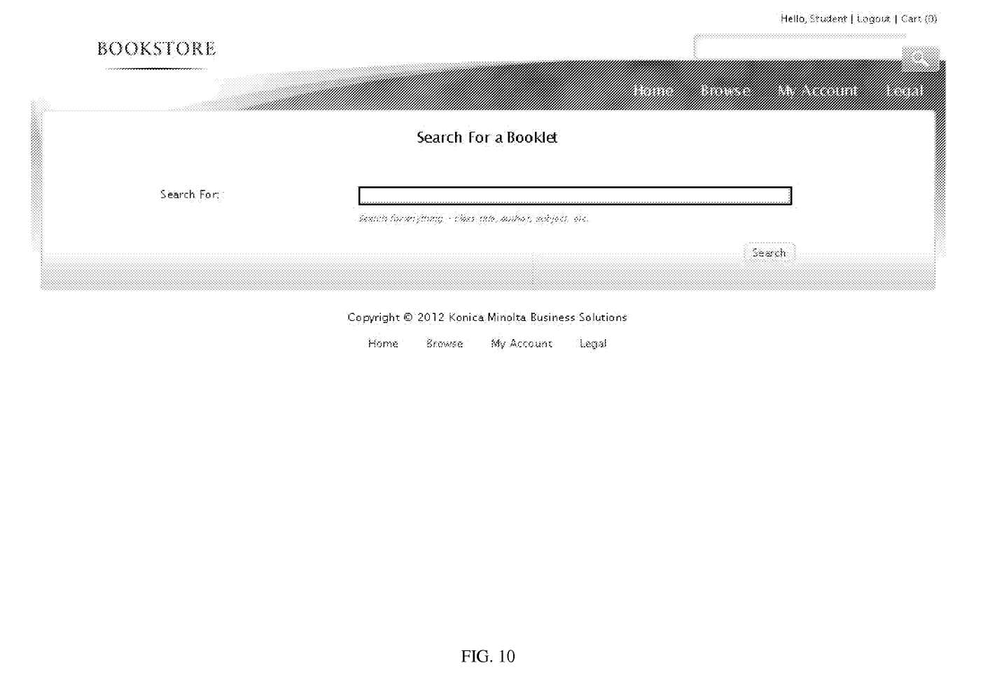

When the reader searches for a particular booklet by clicking on the “Search Now” button at the lower left portion of the home page as shown in FIG. 3, a search page is displayed as shown in FIG. 10. This allows a reader at Step 232 shown in FIG. 25 to search for a booklet.

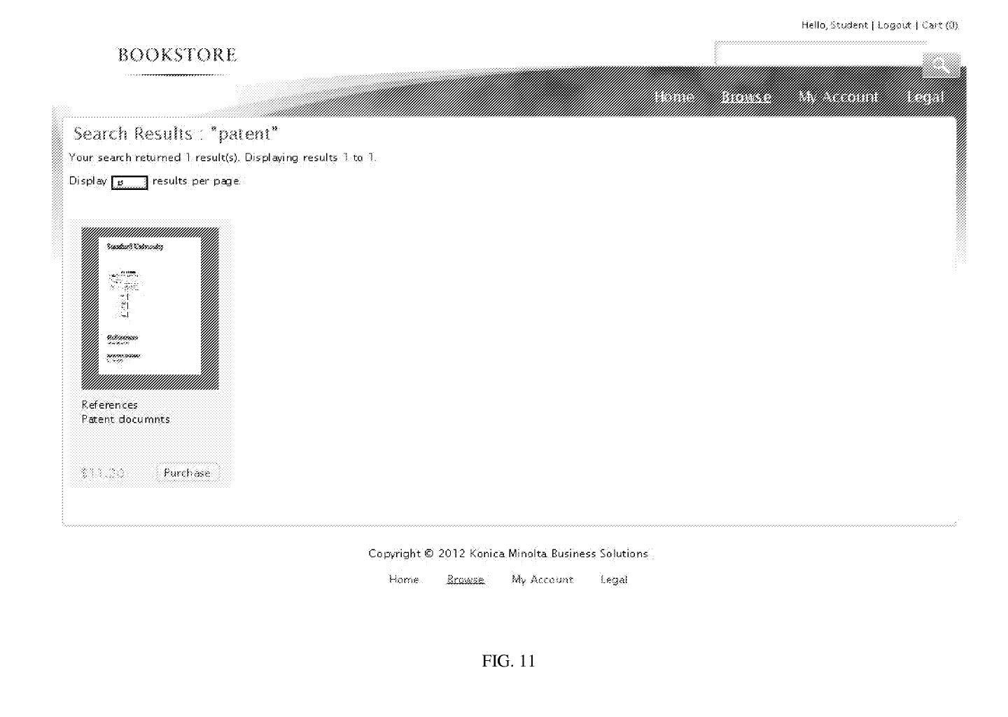

Referring to FIG. 10, on the search screen a text box is provided to the reader. The reader may type in any search criteria or key words, such as title, author, subject, etc. of a booklet, and the search will return all booklets that match the search criteria, as shown in FIG. 11.

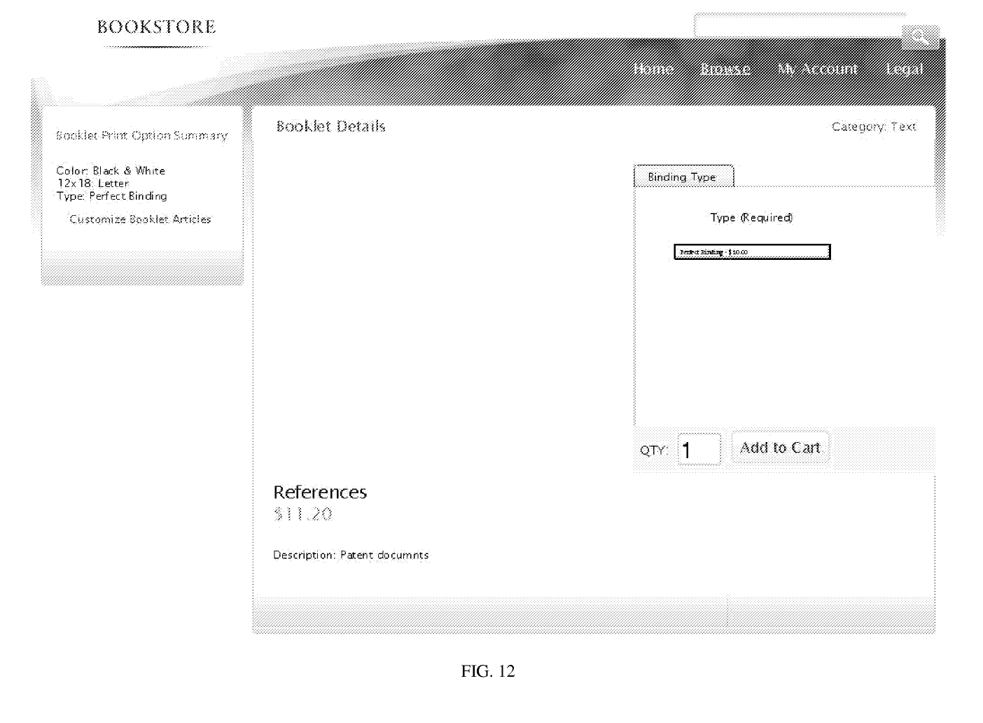

Referring to FIG. 11, there is shown the search result. In the example the booklet “Reference—Patent Documents” is found to match the search criteria and therefore displayed. The GUI of this page is the same as the one shown in FIG. 9. Both pages show a booklet is found for purchase by the reader. At Step S170 shown in FIG. 2 the reader may purchase the booklet by clicking on the “Purchase” button shown under the thumbnail image of the booklet cover as shown in FIG. 9 and FIG. 11, which leads to the next page shown in FIG. 12.

Referring to FIG. 12, there is shown a screen shot of an exemplary GUI display of a reader's option page of the online platform web-site. On this page the reader may view and select the booklet purchase options associated with various hybrid purchase rights of the booklet, which is Step S180 shown in FIG. 2, and at Step S190 shown in FIG. 2 the reader may elect to exercise the options with hybrid rights purchased. The hybrid purchase rights may include, for example, delivery format options, contents reproduction options, timing options, location options, etc. For example the format options may allow the reader to purchase and use the booklet in either the electronic or print form or both at Step 192 shown in FIG. 2. The contents options may allow the reader to selectively use certain contents in one form but other contents in another form at Step 194 shown in FIG. 2. For example, a booklet may include a video clip that may be delivered in electronic form and viewed by the reader on the reader's electronic device such as a laptop computer, a tablet computer, a smart phone or an e-reader, whereas other portions of the booklet in, e.g., the portable document format (PDF) may be printed in hard copy. The timing options may allow the reader to exercise their rights at different time periods at Step 196 shown in FIG. 2. For example a reader may pay for the price of purchasing an electronic copy of a booklet and exercise the option of printing part one of the booklet at a given time, and exercising the option of printing part two of the booklet at a subsequent time, and so on, and only pay for the costs associated with printing the respective part of the booklet at the time that such part is printed in hard copy. The location options may allow the reader to exercise his or her rights at different locations at Step 198 as shown in FIG. 2. For example a student reader who has purchased a printed copy of a booklet may access and view an electronic version of the booklet free of charge within the campus of an educational institution.

As shown in FIG. 1, an electronic or digital copy 20 of a booklet purchased may be delivered electronically via the network 10 or any other suitable manner, whereas copy 30 of a booklet purchased may be delivered directly (or indirectly) from the print shop 8 to the customer 4 in any suitable manner.

According to the exemplary embodiments of the present invention, the hybrid purchase model focuses on the delivery aspect, i.e., the right to the hard copies may be dependent upon and derivative from the right to the electronic or digital copy of a booklet. Of course the author or compiler or publisher of a booklet may assign priority of the form of the booklet to control which form of the booklet may be purchased and delivered first. A reader may purchase and pay for the right to the electronic copy of the booklet, and exercise and pay for the right to the whole or a portion of the booklet in print form at a later time. In addition, the reader has much greater flexibility in exercising the rights. For example, a reader may purchase both rights, in a flexible way, to either an electronic or a hard copy, or multiple hard copies, in any combination, and pay only for the price when such rights are purchased or the options are exercised. The hybrid purchase model also provides control to the author or publisher as to how the booklet may be used or how the rights may be exercised. For example, the electronic version of a content of a booklet, such as a video clip, may be allowed to be viewed on an electronic device but not captured or stored otherwise. As another example, the printing options of the hard copy version of the may also be restricted to maintain the quality of the print form such as only professional grade copies may be produced.

When a reader purchases an electronic copy of a booklet, there may be various additional use options and rights associated therewith. For example, the electronic copy may have links to view additional online contents (e.g., video, webpage, etc.). The electronic version may also be archived for life cycle of the courses of a study.

It is contemplated that both the electronic and hard copies of a booklet will have objects for a reader to obtain the other version. For example, on the electronic or digital version the object may include metadata which indicates the right to print hard copies, the number of copies that are allowed to be made in printed form, the time that hard copy may be produced, etc. For example if the purchaser of the electronic version of a course booklet is a student, then the metadata may contain code that limit the number of hard copies may be produced to be one, whereas if the purchaser of the electronic version of the course booklet is a teacher, then the metadata may contain code that allows the number of hard copies may be produced to be equal to the number of students that the teacher is teaching for the course. Of course there may be options to buy additional print rights when a user needs to print more hard copies.

On the print form the object may be barcode, such that a reader may scan the barcode with his or her smart phone or tablet computer to download the electronic version of the booklet. Alternatively access URL and login information (such as user name and password) may be printed on the hard copy so that a reader may access the digital copy from a browser for flash based documents or other protected format.

When the right of an electronic copy of a booklet is purchased, the publisher or bookstore may deliver an application to the smart phone or tablet computer of the reader to facilitate the reader to use and view the electronic copy or produce and print a whole or part of the booklet subsequently. The reader may make incremental purchases of reproduction or use rights based on need. Such incremental purchases may be controlled in accordance with a timeline upon which one or both of the forms may be needed at different time periods.

The hybrid purchase model in accordance with the exemplary embodiments of the present invention has many advantageous features. It provides a flexible way for printed and electronic distribution of books and compilation of works and the like. The hybrid purchase combines electronic rights and rights to a printed copy as well. The electronic copies may contain embeddable multimedia contents, whereas the hard copies may contain links to another type of multi-media contents to provide a digital extension of what cannot be printed on paper (e.g., a music piece or a video clip). A reader may read on a tablet, a smart phone or an e-reader of a booklet in digital form, and print only the portion of the booklet in hard copy as needed. Such hybrid purchase rights allow great content flexibility and customization. A reader does not need to buy all the rights at once. The readers may elect to purchase the digital or print rights only and if they want the other rights, they just pay an additional price for the added rights. Access to this option can be embedded in their original purchase (e.g., in metadata of an electronic copy or a barcode of a hard copy) that may be used to activate additional options. The reader can simply pay for the price of the new format and then get access to the new format. The exercising of the rights may also be time-line or geographically based, as needed.

The above described process may be implemented by a computer software program. The present invention also provides a computer program product that includes a computer usable non-transitory medium (e.g. memory or storage device) having a computer readable program code embedded therein for controlling a data processing apparatus, the computer readable program code configured to cause the data processing apparatus to execute the above described process.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for controlling rights for purchasing and using a compilation of works, comprising the steps of:
compiling the compilation of works;
obtaining rights to use the compilation of works in different formats;
setting different options for a user to purchase the rights to use the compilation of works in different formats; and
allowing a user to purchase the rights to use the compilation of works with different options such that they may be exercised based on the user's needs.

2. The method of claim 1, wherein the different formats include an electronic digital format and a hard copy print format.

3. The method of claim 2, wherein the different purchase options further comprise a format option which allows the compilation of works to be used in different combinations, including using the electronic digital format alone, using the hard copy print format alone, and using the electronic digital format and the hard copy print format together.

4. The method of claim 1, wherein the different purchase options further comprise a contents option which allows different contents of the compilation of works be used in different formats.

5. The method of claim 1, wherein the different purchase options further comprise a timing option which allows the compilation of works be used in different formats at different times.

6. The method of claim 1, wherein the different purchase options further comprise a location option which allows the compilation of works be used in different formats at different locations.

7. The method of claim 2, further comprising the step of embedding metadata in the electronic digital format of the compilation of work to control subsequent use rights of the compilation of works in the hard copy print format.

8. The method of claim 7, wherein the embedded metadata in the electronic digital format of the compilation of work controls the number of copies that the compilation of works can be subsequently printed in the hard copy print format.

9. The method of claim 2, further comprising the step of printing a barcode on the hard copy print format of the compilation of work to control subsequent use rights of the compilation of works in the electronic digital format.

10. The method of claim 2, further comprising the step of printing a link on the hard copy print format of the compilation of work to provide a source from which the compilation of works can be subsequently obtained in the electronic digital format.

11. A computer program product comprising a non-transitory computer usable medium having a computer readable code embodied therein for controlling a data processing apparatus, the computer readable program code configured to cause the data processing apparatus to execute a process for controlling rights for purchasing and using a compilation of works, the process comprising the steps of:
compiling the compilation of works;
obtaining rights to use the compilation of works in different formats;
setting different options for a user to purchase the rights to use the compilation of works in different formats; and
allowing a user to purchase the rights to use the compilation of works with different options such that they may be exercised based on the user's needs.

12. The computer program product of claim 11, wherein the different formats include an electronic digital format and a hard copy print format.

13. The computer program product of claim 12, wherein the different purchase options further comprise a format option which allows the compilation of works to be used in different combinations, including using the electronic digital format alone, using the hard copy print format alone, and using the electronic digital format and the hard copy print format together.

14. The computer program product of claim 11, wherein the different purchase options further comprise a contents option which allows different contents of the compilation of works be used in different formats.

15. The computer program product of claim 11, wherein the different purchase options further comprise a timing option which allows the compilation of works be used in different formats at different times.

16. The computer program product of claim 11, wherein the different purchase options further comprise a location option which allows the compilation of works be used in different formats at different locations.

17. The computer program product of claim 12, wherein the process further comprises the step of embedding metadata in the electronic digital format of the compilation of work to control subsequent use rights of the compilation of works in the hard copy print format.

18. The computer program product of claim 17, wherein the embedded metadata in the electronic digital format of the compilation of work controls the number of copies that the compilation of works can be subsequently printed in the hard copy print format.

19. The computer program product of claim 12, wherein the process further comprises the step of printing a barcode on the hard copy print format of the compilation of work to control subsequent use rights of the compilation of works in the electronic digital format.

20. The computer program product of claim 12, wherein the process further comprises the step of printing a link on the hard copy print format of the compilation of work to provide a source from which the compilation of works can be subsequently obtained in the electronic digital format.
